(19) United States
(12) Patent Application Publication
(10) Pub. No.: US 2003/0071070 A1
(43) Pub. Date: Apr. 17, 2003

(54) Dosing and distruting device for products in powder form and similar

(76) Inventor: Delphine Jouve, Treffort-Cuisiat (FR)

Correspondence Address: Oliff & Berridge, PO Box 19928, Alexandria, VA, 22320, US

(21) Appl. No.: 10/168,998

(22) PCT Filed: Jan. 10, 2001
(86) PCT No.: PCT/FR01/00071

(30) Foreign Application Priority Data
Jan. 10, 2000 (FR) 00/00245

(51) Int. Cl. B67D 5/06

(52) U.S. Cl. 222/205; 222/444

(57) ABSTRACT

The inventive dosing and distributing device consists of a support (1) with a mounting base (5) which can be adapted on the top of a receptacle (4) containing the product to be distributed; a dosing chamber (2) and calibrating means, such as a calibrated piston (3). Said support (1) comprises a cylindrical body (6) in which the dosing chamber (2) is mounted in such a way that it can rotate. The piston (3) is introduced into the dosing chambre (2), where it delimits a cavity (25) corresponding to the dose to be distributed. Said cavity is filled by turning the receptacle (4), through openings arranged so that they correspond. Once the metering chamber (2) has been rotated, the dose of the product to be distributed is delivered by a pouring spout (10) that is formed on the support (1), through other openings which are also arranged in such a way that the correspond. A dosing and distributing device of this type can be used for distributing pharmaceutical products in the form of microbeads or microgranules.

The present invention relates to a dispenser for products in powder form and the like. This invention applies in particular, but not exclusively, to distribution and dispensing of pharmaceutical products that are in the form of microbeads or microgranules.

When drugs of the classical or homeopathic type are prescribed, they must be taken in precise amounts at specific time intervals; the doses may vary according to the medical prescription and according to the weight of the patient, particularly when a distinction is made between “pediatric” and “adult” dosage forms.

To facilitate the taking of such drugs, dispensing devices have already been proposed that are generally associated with a receptacle containing a greater or lesser amount of the product in question, designed to isolate a predefined dose of this product before dispensing it.

In the case of the classical pillbox, or homeopathic granules, which are unit products with well-defined, measurable dimensions, known dispensers are designed either to deliver these products one by one, or to dispense a specific whole number of units of these products each time they are used.

Such devices are unsuitable for pharmaceutical or other products that are in the form of a relatively fine powder. Indeed, in the latter case, a precise volume of powdered product (assumed to correspond to a given weight or predefined quantity of the active principle of the drug) needs to be isolated, then this volume of product dispensed, with no risk that some fraction of the product volume will be lost.

A number of proposals have already been made for dispensers of powdered products. In this regard, the following examples may be cited: French Patents Nos. 2,550,168 and 2,755,431, and International Patent Applications Nos. WO 86/02997, WO 88/07483, and WO 98/12128.

In general, these known devices have the following drawbacks:

they are usually built into receptacles, particularly cylindrical receptacles, containing the product to be dispensed, which imposes dimensional constraints with no direct relationship to the doses to be dispensed, as well as a purely rotary operating principle;

most of these devices do not enable the doses dispensed to be adjusted or selected;

certain known devices enable the dose dispensed to be adjusted (for example the aforesaid French Patent No. 2,550,168 and International Patent Application No. WO 98/12128) but their regulating means are complex in design and there is no assurance that the setting will hold over time.

The goal of the present invention is to avoid all these drawbacks by supplying a dispenser for products in powder form and the like that is simple in design and easy to use, and enables the dispensed product dose to be adjusted while maintaining the setting over time, with this device being outside any receptacle so that its dimensions can be defined essentially according to the doses to be dispensed in order to ensure consistency and accuracy of these doses.

For this purpose, the invention relates to a dispenser for products in powder form and the like, comprised essentially, in combination:

of a support having a base fittable onto the top of a receptacle containing a product in powder form or the like to be dispensed, and a hollow cylindrical body mounted on the base, the cylindrical body being open at its top but closed at its bottom by a wall in which at least one lower opening is provided, the cylindrical body having at its bottom at least one lateral opening extended radially outward by a pour spout;

of a dispensing chamber of hollow cylindrical shape, open at its upper part and provided at its base with a bottom in which at least one opening is provided, with the base of the side wall of the dispensing chamber having a lateral opening and this dispensing chamber being mounted in the cylindrical body of the support so that it can rotate between a first angular position in which the opening or openings in its bottom coincide with the lower opening or openings in the support, and a second angular position in which the lateral opening of said dispensing chamber coincides with the lateral opening in the cylindrical body of the support, operating means being provided to rotate the dispensing chamber between the two aforesaid angular positions;

of calibration means serving to delimit a cavity of predefined volume corresponding to one dose for dispensing, inside said dispensing chamber.

Preferably, the calibration means, serving to delimit a cavity of predefined volume in the dispensing chamber, corresponding to a dose for dispensing, are comprised of a calibrated plunger with a predetermined height that is less than the height of the dispensing chamber, the plunger being inserted into and held in said dispensing chamber in order to delimit, between the bottom of this chamber and the base of said plunger, a cylindrical cavity whose volume corresponds to the dose to be dispensed.

Alternatively, the calibrated plunger may be eliminated and the calibration means be directly built into the dispensing chamber, for example in the form of a wall located at an appropriate height.

Thus, the dispenser according to the invention has the following method of operation in its preferred embodiment:

the desired dose is selected by placing the corresponding calibrated plunger in the dispensing chamber;

the assembly comprised of the support, the dispensing chamber, and the support is mounted on the receptacle filled with the powdered product to be dispensed;

this receptacle, equipped with the dispenser, is turned over allowing the dispensing chamber, or at least the cavity delimited in this chamber by the plunger, to be filled with the powdered product flowing under the influence of gravity through the openings in the bottom of said chamber and in the support, which have been made to coincide;

the dispensing chamber is rotated relative to the support and the receptacle is turned over once again so that the dose of product previously isolated can exit via the pour spout, passing through the lateral openings in the support and the dispensing chamber that had been made to coincide.

In one preferred embodiment of the invention, the base of the support has a circular shape and at its periphery is provided with means for fitting it, in particular by snapping or screwing, to the top of the receptacle.

Advantageously, to ensure accurately dispensed quantities of powdered product, the cross section or diameter of the cylindrical body and hence also the cross section or diameter of the dispensing chamber and the plunger is substantially less than the cross section or diameter of the base of this support.

In one particular embodiment, the support has two lower openings in the shape of sectors of a circle and diametrically opposite each other, with the bottom of the dispensing chamber also having two openings in the shape of sectors of a circle and diametrically opposite each other.

Preferably, the pour spout of the support has a tilted bottom and extends radially beyond the outer edge of the base of this support.

The operating means provided for rotating the dispensing chamber between the two aforesaid angular positions may be comprised of a knurled wheel provided at the top of said chamber. Other means are advantageously provided to index the dispensing chamber, relative to the support, in the two aforesaid angular positions.

The dispensing chamber may additionally have labels readable from the outside and able to come into correspondence with a mark or window in the support in order to identify and distinguish the two aforesaid angular positions.

Using the dispenser is rendered still more practical and safe by making the support and dispensing chamber of transparent material, or at least with transparent “windows” enabling the degree of filling then emptying of the cavity delimited between the bottom of the dispensing chamber and the base of plunger to be checked.

The calibrated plunger preferably has at its top a shape cooperating with a corresponding shape provided in the top of the dispensing chamber to keep this plunger in a predefined axial position relative to said dispensing chamber, and thus ensure that the dose dispensed is fixed.

Likewise advantageously, the plunger has, at its top, a projecting tab on which the value of the corresponding dose is inscribed, which value remains legible even when the plunger has been inserted into the dispensing chamber.

The calibrated plunger described thus far as a single component preferably belongs to a series of plungers with the same cross section or diameter, but graduated heights, with this series of plungers corresponding to a range of preset doses. In particular, all these plungers can initially be bunched into a plunger “cluster” from which the user detaches the plunger corresponding to the desired dose.

Overall, the dispenser for products in powder form and the like according to the invention has the following advantages:

This dispenser is simple and economical to manufacture industrially as its components are few, easily cast, and easily assembled with each other;

Designed as an accessory independent of the receptacle containing the product to be dispensed, but fitting on this receptacle, the dispenser according to the invention can be dimensioned essentially according to the doses to be dispensed, particularly with a relatively small-diameter dispensing chamber and piston, on the order of one centimeter for a minimum dose of 0.3 milliliter, ensuring accuracy of the desired dose (indeed, the smaller the cross section of the dispensing chamber, the smaller the volume discrepancy for a given uncertainty as to the height or position of the plunger);

The dispensed dose value can be very easily selected by the initial choice, or replacement, of the calibrated plunger inserted into the dispensing chamber;

Once the “right” plunger is in place, the dispenser becomes non-adjustable so that the doses successively dispensed remain consistent over time.

The dispenser is easy to use and easy to manipulate by both a right-handed and a left-handed operator by simple movements without major effort.

The use of the dispenser is further facilitated by the visibility of the product, in the case of a transparent design, enabling the cleanliness of the dispensing system to be checked;

Because of the configuration of the pour spout, this dispenser can be used with no risk of spilling some of the product by faulty pouring, which contributes to clean and easy utilization ensuring that the dose selected is the dose actually poured;

Finally, although it is not built into a receptacle, the dispenser according to the invention can be easily stored in a package containing both the receptacle and the dispenser.

In view of all these advantages, the dispenser according to the invention is particularly suitable for dispensing doses of pharmaceutical products in the form of microbeads or microgranules.

In any event, the invention will be better understood with the aid of the following description with reference to the schematic drawings attached that show one embodiment of this dispenser for products in powder form and the like, as an example:

FIG. 1 is a general exploded view of a dispenser according to the invention, the components thereof being seen from above;

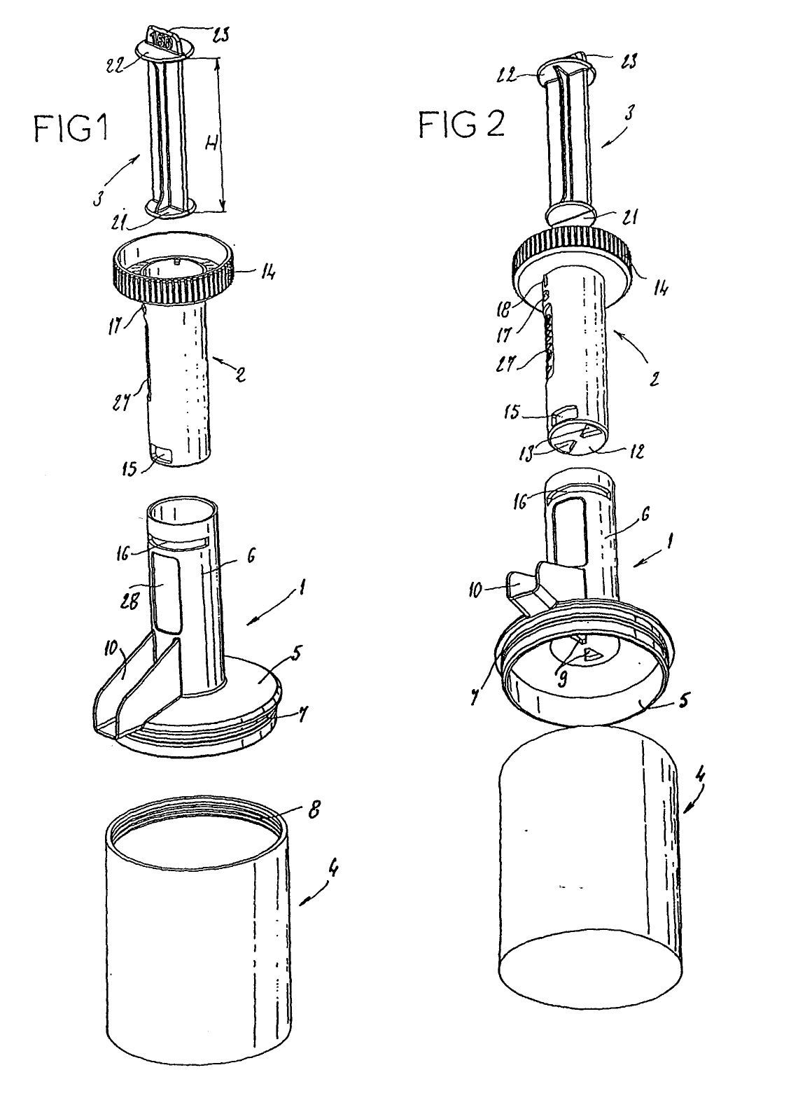

FIG. 2 is another general exploded view of this dispenser, the components thereof being seen from below;

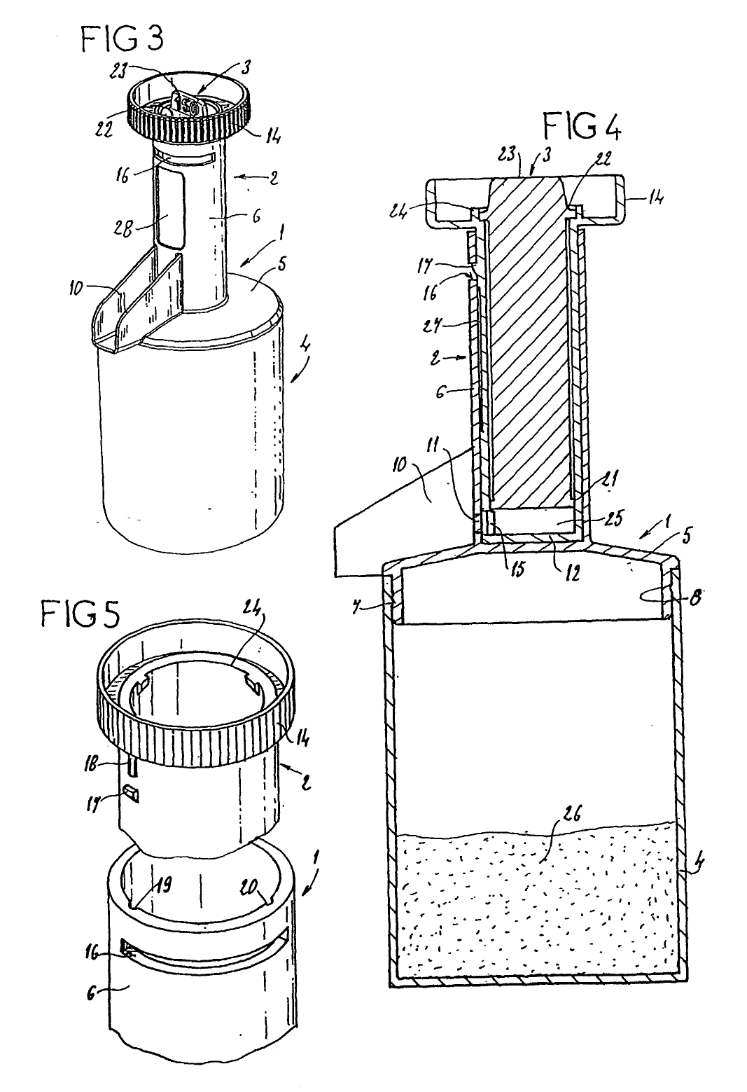

FIG. 3 is a general exploded view of the same dispenser in the assembled state and fitted to a receptacle;

FIG. 4 is a general view in vertical section of this dispenser fitted on a receptacle;

FIG. 5 is a perspective view on an enlarged scale of a detail of the dispenser from the foregoing figures;

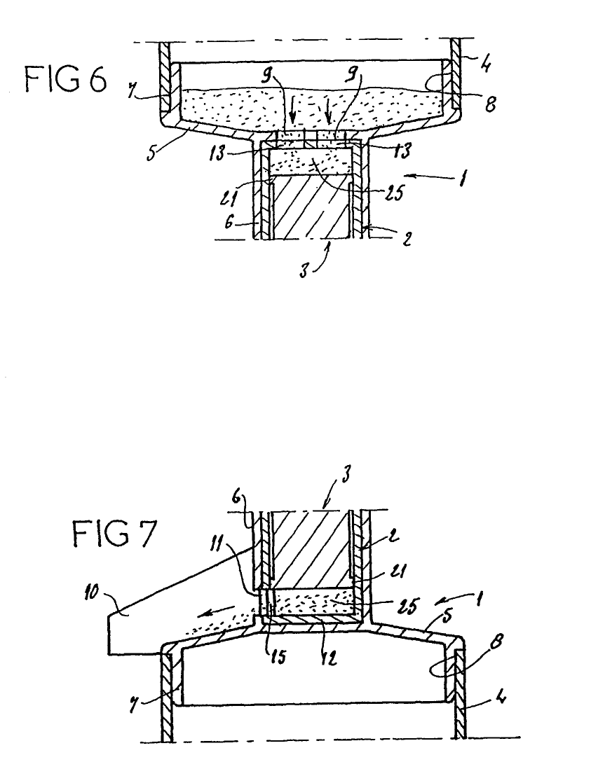

FIGS. 6 and 7 are partial cross-sectional views of this dispenser, illustrating two successive phases of its use;

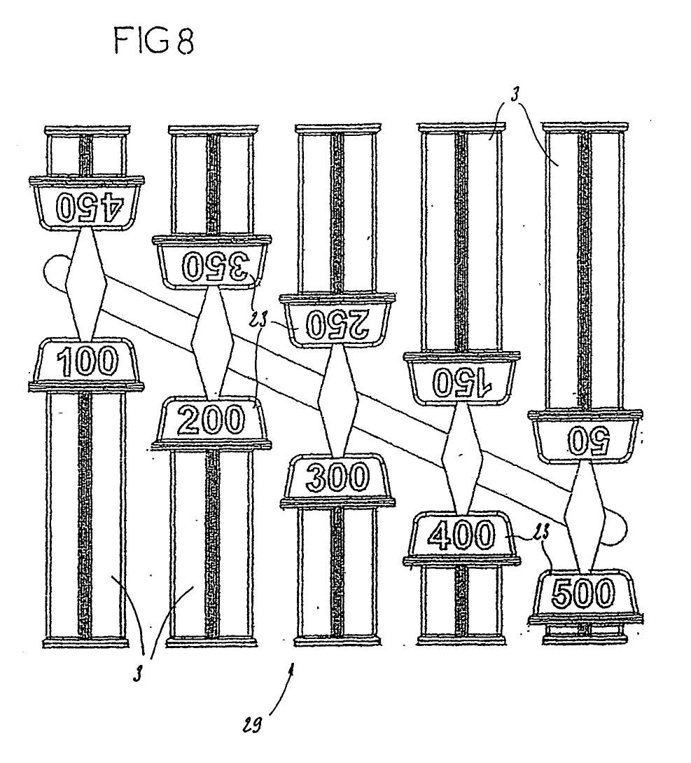

FIG. 8 shows a series of plungers that can be used with the same dispenser.

As shown in FIGS. 1 and 2, the dispenser according to the invention is composed of three parts, namely a support 1, a dispensing chamber 2, and a calibrated plunger 3, this assembly being fittable on a receptacle 4 such as a rigid tube, able to contain a powdered product to be dispensed in precise preset doses.

Support 1 has a circular base 5 surmounted coaxially by a hollow cylindrical body 6 whose diameter is substantially smaller than that of base 5. In particular, the diameter of base 5 is adapted to that of receptacle 4, and arrangements are provided, as indicated at 7 and 8, to snap support 1 by its base 5 sealably onto the top of receptacle 4 (see also FIGS. 3 and 4).

The cylindrical body 6 of support 1 is open at the top. At its base, this cylindrical body 6 is essentially closed by a horizontal wall, but two lower openings 9 in the shape of sectors of a circle, diametrically opposite each other, are provided in this wall and cause the inside space of said body 6 to communicate with the bottom of base 5.

Support 1 also has a pour spout 10 provided just above its base 5, at the lower part of cylindrical body 6. Pour spout 10 extends radially beyond the outer circular edge of base 5. The cylindrical wall of body 6 has at its base a rectangular lateral opening 11 (see also FIG. 7) providing a communication between the inside space of said body 6 and the inside of pour spout 10. The bottom of this pour spout 10 is at an angle to the horizontal.

Dispensing chamber 2 has a hollow cylindrical shape. At its base, this dispensing chamber 2 has a bottom 12 in which two openings 13 are provided, in the shape of diametrically opposite sectors of a circle. Dispensing chamber 2 is open at the top, which is enlarged diameter-wise to form a knurled wheel 4. The side wall of said dispensing chamber 2 has a rectangular opening 15 at its base.

The outside diameter of dispensing chamber 2 corresponds to the inside diameter of the cylindrical body 6 of support 1, and the heights of this dispensing chamber 2 and cylindrical body 6 are substantially the same so that the dispensing chamber 2 can be rotatably mounted inside cylindrical body 6 of support 1; FIGS. 3 and 4 show these two parts nested.

To hold dispensing chamber 2 in cylindrical body 6 of support 1, an arcuate slot 16 is provided near the top of the side wall of said body 6, into which slot fits a projection 17 formed on the outside of the side wall of dispensing chamber 2 at the corresponding height—see in particular FIG. 5. The length of the slot 16 determines the degree of rotation permitted for dispensing chamber 2 relative to support 1, this being in particular 90°.

In addition, in order to index the dispensing chamber 2 in the two extreme angular positions of its rotational movement, the chamber has on the outside, just under its wheel 14, a small rounded bulge 18 that is able to cooperate with either one of small recesses 19 and 20 provided inside the top of the wall of cylindrical body 6 of support 1—see also FIG. 5.

Plunger 3, which has a cruciform cross section for example, has between its base 21 and its top 22 a predetermined height H that is less than the height of dispensing chamber 2. The base 21 of plunger 3 is disk-shaped and its diameter corresponds to the inside diameter of dispensing chamber 2. The top 22 of plunger 3 is also disk-shaped and is surmounted by a vertical tab 23 on which the value of the dose corresponding to this plunger 3 is marked.

When the dispenser is used, plunger 3 (chosen according to the dose to be dispensed) is inserted into the dispensing chamber 2, the upper disk 22 of this plunger 3 being held by cooperation with a corresponding annular shape 24 provided at the top of dispensing chamber 2—see in particular FIG. 4. A cylindrical cavity 25 with a precisely defined volume is thus delimited in the dispensing chamber 2 between the bottom 12 of this chamber 2 and the lower disk 21 of plunger 3.

The aforesaid dispenser is used as follows:

This dispenser, namely the assembly comprised of support 1, dispensing chamber 2, and calibrated plunger 3 assembled together, is mounted on the tube or other receptacle 4 containing some quantity of powdered product 26 to be dispensed in a dose (see FIG. 4). The dispenser is assumed to be equipped with a calibrated plunger 3 corresponding to the desired dose.

By means of its knurled wheel 14, dispensing chamber 2 is brought into an extreme angular position relative to support 1 so that the two openings 13 in bottom 12 of said dispensing chamber 2 coincide with the two openings 9 of support 1. In this relative position, the lateral opening 15 of the dispensing chamber 2 is angularly offset from the lateral opening 11 in the cylindrical body 6 of support 1.

The assembly comprised of the dispenser and receptacle 4 is then turned over so that cavity 25 of the dispensing chamber 2 can fill as the powdered product 26 runs under the influence of gravity into this cavity 25 from receptacle 4 through coinciding openings 9 and 13—see FIG. 6.

It will be noted that, in order for this utilization phase to be visually inspected, support 1 and dispensing chamber 2 are advantageously made of transparent material or at least with transparent “windows” so that actual and complete filling of cavity 25 can be ensured.

Next, the assembly is once more turned over into its rotational orientation, and dispensing chamber 2 is rotated by its knurled wheel 14 into its other extreme angular position. In this position, the two openings 13 in bottom 12 of dispensing chamber 2 no longer coincide with openings 9 in support 1; on the contrary, the lateral opening 15 in dispensing chamber 12 is made to coincide with the lateral opening 11 in cylindrical body 6 of support 1. Thus, as shown in FIG. 7, the dose of powdered product previously isolated in cavity 25 runs under the influence of gravity into pour spout 10 and can thus fall into a receptacle, or onto food which is placed at the side of receptacle 4.

At the next use, repetition of the same steps enables a further dose of powdered product 26, identical to the previous dose, to be dispensed.

To facilitate use of the dispenser, the dispensing chamber 2 advantageously has explicit labels 27 on its cylindrical side wall such as “FILL” and “EMPTY,” legible from the outside because they can be seen through a transparent “window” 28 provided in the wall of cylindrical body 6 of support 1—see in particular FIGS. 1 and 2.

As will readily be understood, the smaller the height H of calibrated plunger 3, the greater the height of cavity 25 and consequently the larger the dose of product isolated in this cavity 25 with each use. The height H of plunger 3 thus directly determines the dose distributed.

In order for a predetermined dose range to be available, one need only provide a series of calibrated plungers 3 all fittable to the same dispensing chamber 2, but differing from each other in their height H. As shown in FIG. 8, such a series of calibrated plungers 3 can be created in particular by one-step casting of a “cluster” 29 of plungers with graduated heights. The user need then only detach, from this cluster 29, the plunger 3 corresponding to the desired dose (identified on tab 23 of this plunger) and place the selected plunger 3 in dispensing chamber 2.

It is also possible po provide two series of plungers of corresponding heights but different diameters to easily obtain two dose ranges, the plungers in the larger-diameter series being intended for example for “adult” doses while the plungers in the smaller-diameter series are intended for “pediatric” doses. As will readily be understood, a given change in the height of a plunger corresponds to a greater or lesser change in the dose, depending on the diameter of this plunger (and of the dispensing chamber).

It will not be a departure from the framework of the invention as defined by the attached claims to make changes in the details of the shapes of the various components (support, dispensing chamber, calibrated plunger) or to integrate the dose-calibration function into the dispensing chamber (in which case the plunger is longer a separate part), or to fit one type of dispenser on any type of receptacle, rigid, semi-rigid, or flexible, for example on a bottle, or to use this dispenser with any product in the powder form or the like, whether it is a drug, a food, a maintenance product, or another product.

1. Dispenser for products in powder form and the like, characterized by being comprised, in combination:
of a support (1) having a base (5) fittable onto the top of a receptacle (4) containing a product (26) in powder form or the like to be dispensed, and a hollow cylindrical body (6) mounted on base (5), the cylindrical body (6) being open at its top but closed at its bottom by a wall in which at least one lower opening (9) is provided, the cylindrical body (6) having at its bottom at least one lateral opening (11) extended radially outward by a pour spout (10);
of a dispensing chamber (2) of hollow cylindrical shape, open at its upper part and provided at its base with a bottom (12) in which at least one opening (13) is provided, with the base of the side wall of the dispensing chamber (2) having a lateral opening (15) and this dispensing chamber (20) being mounted in cylindrical body (6) of support (1) so that it can rotate between a first angular position in which the opening or openings (13) in its bottom (12) coincide with the lower opening or openings (9) in support (1), and a second angular position in which the lateral opening (15) of said dispensing chamber (2) coincides with the lateral opening (11) in the cylindrical body (6) of support (1), operating means (14) being provided to rotate the dispensing chamber (2) between the two aforesaid angular positions;
of calibration means (3) serving to delimit a cavity (25) of predefined volume corresponding to one dose for dispensing, inside said dispensing chamber (2).

2. Dispenser according to claim 1, characterized in that said calibration means, serving to delimit a cavity of predefined volume in dispensing chamber (2), corresponding to a dose for dispensing, are comprised of a calibrated plunger (3) with a predetermined height (H) that is less than the height of dispensing chamber (2), plunger (3) being inserted into and held in said dispensing chamber (2) in order to delimit, between the bottom (12) of this chamber (2) and the base (21) of said plunger (3), a cylindrical cavity (25) whose volume corresponds to the dose to be dispensed.

3. Dispenser according to claim 1, characterized in that said calibration means are directly built into the dispensing chamber (2).

4. Dispenser according to any one of the foregoing claims 1 to 3, characterized in that the base (5) of support (1) has a circular shape and at its periphery is provided with means (7) for fitting it, particularly snapping or screwing it, onto the top of 44 (4).

5. Dispenser according to either of the foregoing claims 1 or 4, characterized in that the cross section or diameter of the cylindrical body (6) of support (1) is substantially less than the cross section or diameter of base (5) of this support (1).

6. Dispenser according to any one of the foregoing claims 1 to 5, characterized in that the support (1) has two lower openings (9) in the shape of sectors of a circle and diametrically opposite each other, with the bottom (12) of dispensing chamber (2) also having two openings (13) in the shape of sectors of a circle and diametrically opposite each other.

7. Dispenser according to any one of the foregoing claims 1 to 6, characterized in that the pour spout (10) of support (1) has a tilted bottom and extends radially beyond the outer edge of base (5) of this support (1).

8. Dispenser according to any one of the foregoing claims 1 to 7, characterized in that means (18, 19, 20) are provided to index the dispensing chamber (2) relative to support (1) in the two aforesaid angular positions.

9. Dispenser according to any one of the foregoing claims 1 to 8, characterized in that the operating means provided for rotating the dispensing chamber (2) between the two aforesaid angular positions are comprised of a knurled wheel (14) provided at the top of said dispensing chamber (2).

10. Dispenser according to any one of the foregoing claims 1 to 9, characterized in that the dispensing chamber (2) has labels readable from the outside and able to come into correspondence with a mark or window (28) in support (1) in order to identify and distinguish the two aforesaid angular positions.

11. Dispenser according to any one of the foregoing claims 1 to 9, characterized in that the support (1) and dispensing chamber (2) are made of a transparent material, or at least with transparent “windows” enabling the degree of filling then emptying of the cavity (25) delimited between bottom (12) of the dispensing chamber (2) and the base (21) of plunger (3) to be checked.

12. Dispenser according to claim 2 and any one of claims 4 to 11, characterized in that the calibrated plunger (3) has at its top a shape (22) cooperating with a corresponding shape (24) provided in the top of dispensing chamber (2) to keep this plunger (3) in a predefined axial position relative to said dispensing chamber (2).

13. Dispenser according to claim 2 and any of the foregoing claims 4 to 11, characterized in that the calibrated plunger (3) has, at its top, a projecting tab (23) on which the value of the corresponding dose is inscribed.

14. Dispenser according to claim 2 and any of the foregoing claims 4 to 13, characterized in that the calibrated plunger (3) belongs to a series of plungers with the same cross section or diameter, but graduated heights (H), particularly plungers (3) initially bunched in a “cluster” (29) of plungers, this series of plungers (3) corresponding to a range of predefined doses.

15. Utilization of the dispenser according to any one of claims 1 to 14 for dispensing doses of pharmaceutical products in the form of microbeads or microgranules.
